(19) United States
(12) Patent Application Publication
(10) Pub. No.: US 2021/0037838 A1
(43) Pub. Date: Feb. 11, 2021

(54) APPARATUS AND METHOD FOR CONVERTING A CHARCOAL GRILL INTO AN INDIRECT HEAT COOKER/SMOKER

(71) Applicant: Moris L. Mills, JR., Palmetto, FL (US)

(72) Inventor: Moris L. Mills, JR., Palmetto, FL (US)

(21) Appl. No.: 16/819,355

(22) Filed: Mar. 16, 2020

Related U.S. Application Data
(60) Provisional application No. 62/884,825, filed on Aug. 9, 2019.

(51) Int. Cl. A23B 4/052; A47J 37/07

(52) U.S. Cl. CPC A23B 4/052; A47J 37/0704

(57) ABSTRACT

A method for converting a charcoal grill into a heat smoker is disclosed. The method comprises inserting a fin at least partially through the grilling surface of the grill such that the fin separates the charcoal grill into a first section and a second section, the fin positioned within the charcoal grill such that charcoal placed within the first section of the charcoal grill is prevented from entering the second section of the charcoal grill, the separation fin including at least one opening configured to allow smoke to pass therethrough, and igniting the charcoal such that air entering the grill through the air vent pulls heat and smoke emanating from the ignited charcoal around the fin and through at least one opening in the fin to smoke food on the grilling surface.

### CROSS-REFERENCE TO RELATED APPLICATION

This application claims priority to U.S. Provisional Patent Application No. 62/884,825, titled, Grill-Fin: Metal Fin That Converts a Charcoal Grill to An Indirect Heat Cooker/Smoker, the disclosure of which is hereby incorporated by reference.

### FIELD

The present disclosure relates to grilling accessories and, more particularly, a fin that converts a charcoal grill to an indirect heat cooker/smoker.

### BACKGROUND

Charcoal grills rely upon airflow to burn the charcoal. However, such airflow can shift directions during cooking thereby changing the temperature along the grill and thus the food cooking thereon. Specifically, a Weber® grill draws air through a bottom flue to heat and burn the charcoal, while a flue on the grill lid aids in drawing the air over the coals, which are usually spread out. The meat is cooked over the coal by the direct heat from the matured coals. Since the airflow can change direction, only peripheral portions of the coals can mature, causing flare-ups and fires if the process is not monitored closely. As a result, cooking on charcoal grills requires constant supervision without which one can burn what they are cooking or light a grease fire. Previous attempts to channel the heat in a more uniform manner have failed to allow enough heat to reach the food being grilled.

Therefore, there is a need for a metal fin that converts a charcoal grill to an indirect heat cooker/smoker. The metal fin uniformly and reliably channels sufficient heat from the coals to be a factor in cooking the food, enabling constant indirect heat to the food being cooked, and therefore eliminating flare-ups and allowing the user to smoke the food if desired. Thus, the present disclosure enables slow cooking of food for more flavor and tenderness.

### SUMMARY

According to one embodiment of the present disclosure, a method for converting a charcoal grill into a heat smoker, the charcoal grill including at least one air vent, a grilling surface situated above a charcoal grate, and a charcoal grate lid configured to allow for the placement of charcoal upon the charcoal grate, is provided. The method includes inserting a fin at least partially through the grilling surface such that the fin separates the charcoal grill into a first section and a second section, the fin positioned within the charcoal grill such that charcoal placed within the first section of the charcoal grill is prevented from entering the second section of the charcoal grill, the separation fin including at least one opening configured to allow smoke to pass therethrough, and igniting the charcoal such that air entering the grill through the at least one air vent pulls heat and smoke emanating from the ignited charcoal around the fin and through the at least one opening in the fin to smoke food on the grilling surface.

In accordance with another embodiment, a fin for converting a charcoal grill into a heat smoker, the charcoal grill including at least one air vent, a grilling surface situated above a charcoal grate, and a charcoal grate lid configured to allow for the placement of charcoal upon the charcoal grate, is provided. The fin includes a top edge, a bottom edge, and two side edges, a front surface, and a back surface, and at least one opening such that air entering the grill through the at least one air vent pulls heat and smoke emanating from ignited charcoal around the fin and through the at least one opening in the fin to smoke food on the grilling surface. The fin is configured to be inserted at least partially through the grilling surface, the insertion of the fin resulting in separation of the charcoal grill into a first section and a second section, such that the fin prevents the charcoal placed in the charcoal grate in the first section of the charcoal grill from entering the second section of the charcoal grill.

In accordance with yet another embodiment, a fin for converting a charcoal grill into a heat smoker, the charcoal grill including at least one air vent, a grilling surface situated above a charcoal grate, and a charcoal grate lid configured to allow for the placement of charcoal upon the charcoal grate, is provided. The fin includes a top edge, a bottom edge, and two side edges, at least one of the two side edges being tapered in order to fit within a curved grill, a front surface, and a back surface, and at least one opening such that air entering the grill through the at least one air vent pulls heat and smoke emanating from ignited charcoal around the fin and through the at least one opening in the fin to smoke food on the grilling surface. The at least opening includes a first column of horizontally disposed slots and a second column of horizontally disposed slots, at least one vertically disposed slot situated between the first column and the second column, a plurality of circular openings situated near the top edge of the fin, and an oval-shaped opening situated between two of the plurality of circular openings, The fin is configured to be inserted at least partially through the grilling surface, the insertion of the fin resulting in separation of the charcoal grill into a first section and a second section, such that the fin prevents the charcoal placed in the charcoal grate in the first section of the charcoal grill from entering the second section of the charcoal grill.

### DESCRIPTION OF THE FIGURES

FIG. 1 is a front view of an exemplary embodiment of the fin of the present disclosure;

FIG. 2 is a front view of the fin of the present disclosure about to be inserted within a charcoal grill;

FIG. 3 is a side view showing the fin of the present disclosure partially inserted within the grill;

FIG. 4 is a front view showing the fin of the present disclosure being fully or nearly fully inserted within the grill;

FIG. 5 shows an open lid to the first section of the grill to allow the insertion of charcoal therein, with the fin of the present disclosure in place;

FIG. 6 shows the charcoal in the first section of the grill and the fin separating the charcoal from the second section of the grill; and

FIG. 7 shows the cover of the grill in place.

### DETAILED DESCRIPTION OF EXEMPLARY EMBODIMENTS

The following detailed description is of the best currently contemplated modes of carrying out exemplary embodiments of the present disclosure. The description is not to be taken in a limiting sense, but is made merely for the purpose of illustrating the general principles of the present disclosure.

Broadly, an embodiment of the present disclosure provides a fin that converts a charcoal grill to an indirect heat cooker/smoker, wherein the fin provides a barrier to maintain the charcoal in one section of the grill and not directly under the food to be cooked, where the fin has openings that channel the heat and smoke from the ignited coals to a predetermined location on the grill.

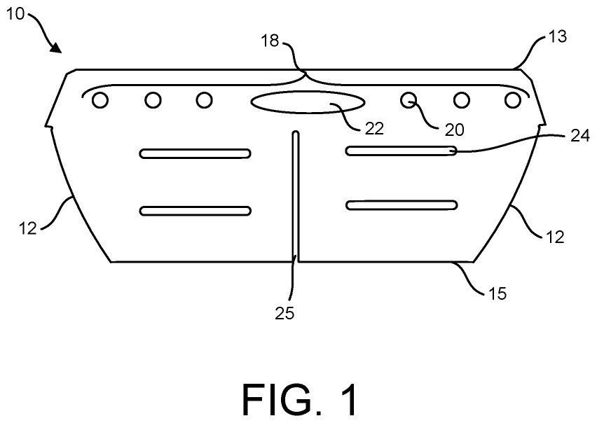

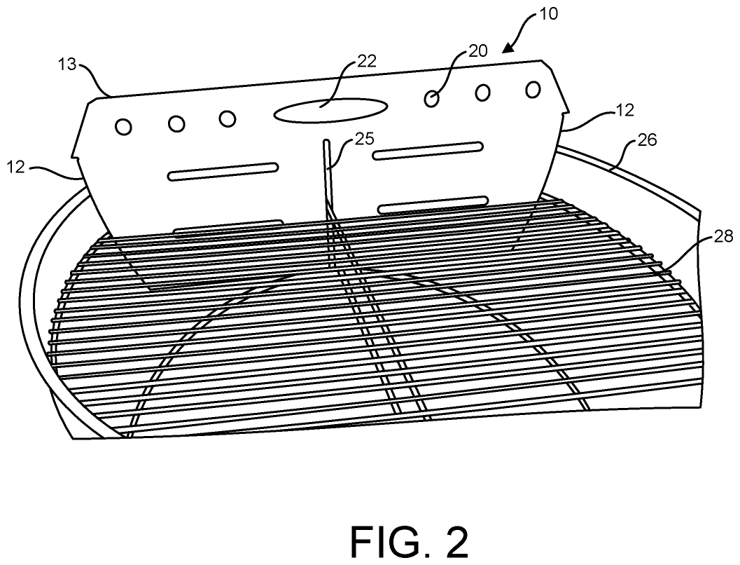

Referring now to FIG. 1, fin 10 of the present disclosure can be seen. Fin 10 may be made of metal or other rigid, heat-resistant material, modified to fit a charcoal grill. Fin 10 includes a front surface and a back surface and is substantially rectangular in shape. However, the shape and dimensions of fin 10 may vary depending upon the grill into which fin 10 is to be inserted. In one embodiment, as shown in the figures, fin 10 is inserted into a substantially circular charcoal grill and thus the sides 12 of fin 10 are tapered to accommodate the curvature of the outer diameter of the grill (as shown in FIG. 2). Fin 10 has a top edge 13 and a bottom edge 15, and a plurality of aerodynamic openings 18. The openings allow air, heat and smoke to be drawn across the charcoals, under, over and around fin 10 and to smoke the food to be cooked which is placed on the grill surface, as will be discussed in further detail below.

As seen in FIG. 1, in this exemplary embodiment, the openings in fin 10 include a series of smaller holes 20 across the top near top edge 13, separated by an oval shaped opening 22. The openings 18 also include two columns, each having two horizontal slots 24 separated by a narrow, vertical slot 25. Note that the number, dimensions and arrangement of the openings 18 shown in FIG. 1 is exemplary only. Fin 10 may include any number and arrangement of openings 18 of varying dimensions. The arrangement and size of the openings 18 may depend on such factors as the type of grill into which separation fin 10 is to be inserted, the type of food that is to be grilled/smoked, the time frame in which to grill/smoke the food, weather (outdoor temperature, wind, etc.,) user preferences (e.g., rare meat, extra smoky flavor) and other factors. Fin 10 may be used with, for example, a Weber® Original Kettle Premium 22-inch Charcoal Grill, model number 14403001, which is the type of grill shown in the figures. Thus, the shape and size of fin 10 and the shape, size, and arrangement of openings 18 may vary depending on the dimensions, and model of the grill in which it will be used.

FIG. 2 shows fin 10 partially inserted within a charcoal grill 26. As discussed above, in the exemplary embodiments shown in the figures, fin 10 is used with a Weber® Original Kettle Premium 22-inch Charcoal Grill, model number 14403001. Fin 10 is configured to be inserted within grilling surface 28 of grill 26, specifically, between the bars that comprise grilling surface 28. Top edge 13 and bottom edge 15, and sides 12 of fin 10 are sized such that they do not interfere with the outer circumference of grill 26. In this embodiment, sides 12 are each tapered so that they do not interfere with the outer circumference of grill 26. Also, the thickness of fin 10 may vary, in order to allow fin 10 to be inserted between the bars of the grilling surface 28.

As will be described below and shown in the figures, fin 10 serves to separate the charcoal grill 26 into two distinct sections such that charcoal that is inserted in one section of the grill 26 is separated from the section of the grill 26 where food is to be placed. Fin 10 is used to retain the coals to one side of grill 26, while the food being grilled is separated and therefore not receiving direct heat and/or fire from the ignited charcoal. While the food is not receiving direct heat and smoke, openings 18 in fin 10 form a flue system that draws heat and smoke from ignited charcoal across the food on the grill surface, resulting in slow cooking with indirect heat.

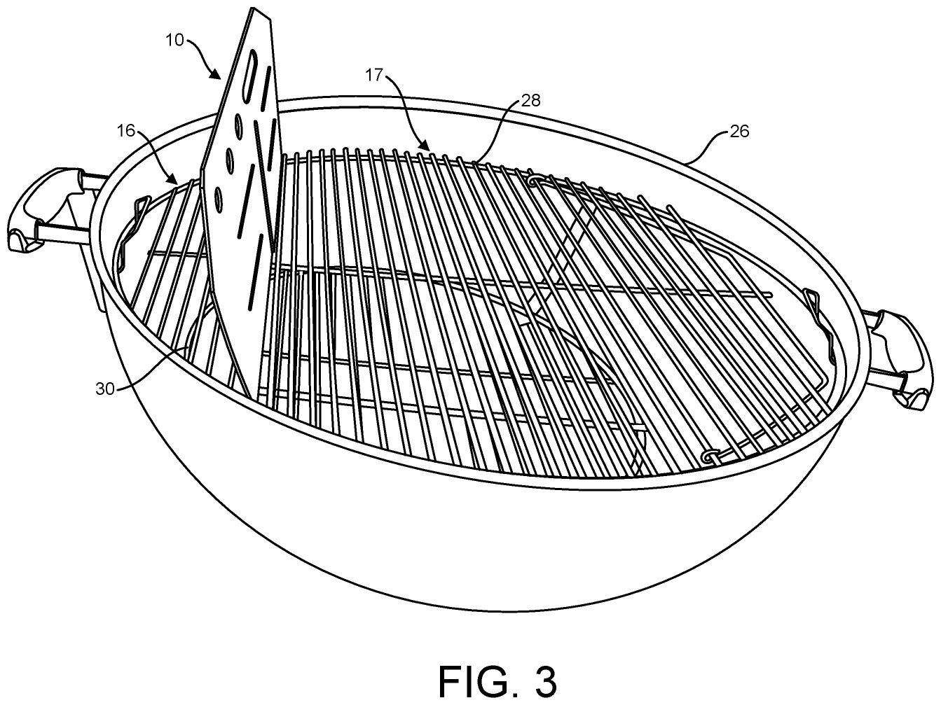

In FIG. 3, fin 10 is shown partially inserted between bars on the grilling surface 28 of grill 26. Fin 10 is inserted far enough within and below grilling surface 28 that it blocks any charcoal that has been placed upon the charcoal grate from getting underneath and too close to the food that is to be grilled/smoked. Fin 10, once inserted, separates grill 26 into a first section 16 behind fin 10 and a second, larger section 17 in front of fin 10. Fin 10 allows charcoal to be placed on a charcoal grate 30 in the first section 16 and separated from the larger second section 17. In this fashion, drippings from food that is placed on the grill surface 28 and bring grilled within the second section 17 of grill 26 do not drip on the ignited charcoal in charcoal grate 30 in first section 18 of grill 26 and possibly cause a flare up or a fire. Further, the openings 18 in fin 10 allow for the heat and smoke from the ignited charcoal to travel through fin 10 to contact the food on grilling surface 28, resulting in indirect smoking of the food. This is explained in further detail below.

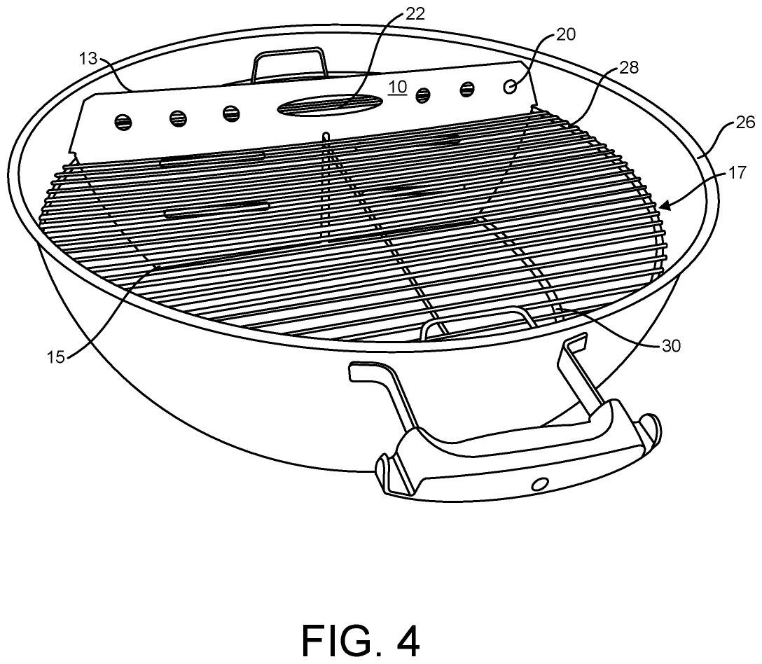

In FIG. 4, fin 10 can be seen fully or substantially fully inserted within bars of grill surface 28. In some embodiments, fin 10 is inserted such that its bottom edge 15 touches charcoal grate 30 and in other embodiments, bottom edge 15 does not touch charcoal grate 30 but is very close to grate 30. In some embodiments, fin 10 fits within a slot in charcoal grate 30 which is aligned with a corresponding slot in grilling surface 28 in order for fin 10 to be properly secured in a substantially vertical orientation. In certain embodiments, edge 13 of fin 10 extends partially out of grilling surface 28, such that at least some of the openings 18 are above grilling surface 28. In the embodiment shown in FIG. 4, when the grill lid is secured on the grill 26, air enters grill 26 through air vents on the lid and holes 20 and oval shaped opening 22 allow for the air entering the interior of grill 26 to travel through fin 10, drawing heat and smoke from the ignited charcoal. In other embodiments, additional openings, e.g., some or all of horizontal slots 24 and/or all or part of vertical slot 25 may also be exposed above grilling surface 28.

When charcoal is added to charcoal grate 30 of first section 16, fin 10, which after insertion, is held in place in a substantially vertical position between bars of grilling surface 28, serves to separate the charcoal from the second section 17 of grill 26. Fin 10 also serves to allow air entering grill 26, along with heat and smoke from the ignited charcoal, to travel over, through and in some embodiments under fin 10 to indirectly “smoke” food being grilled on grilling surface 26 in the second section 18. Thus, fin 10 serves a dual purpose of, first, separating the charcoal such that drippings from the grilled food do not splatter on the charcoal, and, second, to allow air, heat and smoke from the ignited charcoal to contact the grilled food, thus providing an indirect “smoker.”

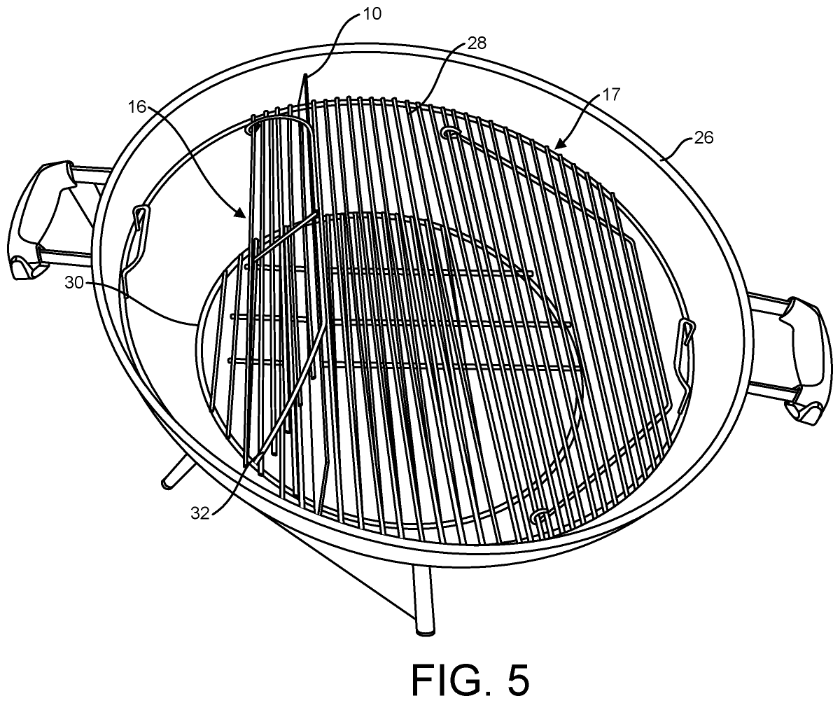

FIG. 5 shows a lid 32 in grilling surface 28 opened to allow for charcoal to be inserted upon charcoal grate 30. As seen in this figure, fin 10 separates grill 26 into first section 16 that is behind fin 10 and which will contain the charcoal, and second section 17 which is in front of fin 10, and which will contain the food that is to be grilled/smoked. Although the figures show first section 16 to be smaller than second section 17, the present disclosure also includes embodiments where this need not be the case. For example, depending upon the grill, or the type of food being grilled, the amount of charcoal needed, or the preference of the user, the size of first section 16 and second section 17 may vary. In other words, fin 10 need not be inserted in the precise location within grilling surface 28 as shown in the figures, but may be inserted more towards the center of grill 26.

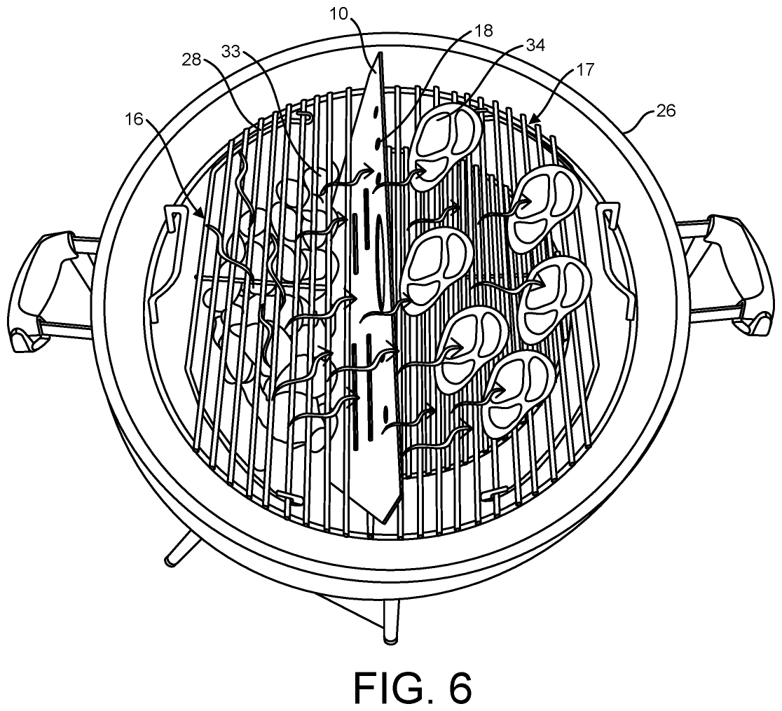

As seen in FIG. 6, charcoal 33 has been added to charcoal grate 30, which is separated from the rest of the grill 26 by fin 10. Thus, charcoal grate 30 in section 16 cannot receive drippings from the grilled food 34 that may fall through grilling surface 28 of second section 17 due to the placement of fin 10. However, while fin 10 is in place, smoke and heat still contacts the food 34 indirectly through openings 18 of fin 10 as well as over and under fin 10. Outside air that enters the interior of grill 26 through one or more air vents on the exterior of the grill 26, helps draw the smoke and heat from the ignited charcoal 33 over fin 10, through the openings 18 in fin 10 and, in some embodiments, under fin 10. The drawn smoke and heat contacts food 34 that is on grilling surface 28 in section 17 of grill 26. In this fashion, food 34 receives indirect heat and smoke, as opposed to direct heat and smoke from underneath it. This provides optimum smoky flavor, while reducing the likelihood of flare ups or fires due to liquid dripping on the charcoal 33.

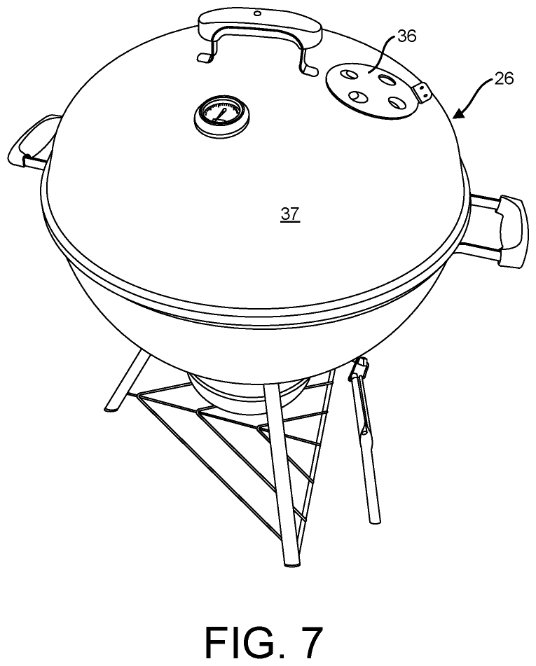

In FIG. 7, lid 37 of grill 26 is in place, covering the food 34 being grilled/smoked. An air vent or baffle 36 can be seen on lid 37. Air baffle 36 allows air to flow into and away from the interior of the grill 26. Air baffle 36 is controllable and the user of the grill 26 can adjust air baffle 36 to allow more or less air to enter the grill 26. In some embodiments, a second air valve or baffle (not shown) is situated at the bottom of the grill 26 closer to where fin 10 resides under lid 37. In this embodiment, the first baffle 36 is placed above the second section 17 of grill 26, i.e., away from the fin 10, while the second baffle on the bottom of the grill 26 is situated closer to fin 10. The combination of the shape of grill 26, the first and second baffles, and the hot charcoals 33 starving for oxygen serve to draw the air into the grill 26. The heat and the smoke from the ignited charcoal 33 are then drawn through fin 10 and the openings 18 therein by the air entering the grill, across the food 34 and then out through air baffle 36 to produce extremely tender, delicious food with a smoky flavor. By adjusting the amount of air that enters grill 26 through air baffle 36 the smoky flavor of the food 34 can be varied. This is all accomplished without flare ups or fires caused by juices dripping on the hot charcoal 33 from food 34, because the charcoal 33 is separated by fin 10 and resides in section 16 and not section 17 where the food resides.

A method of using fin 10 of the present disclosure may include the following. Fin 10 as described herein is provided. A user may deposit charcoal 33 in upon charcoal grate 30 and ignite charcoal 33 in a conventional manner (charcoal starter, chimney or log, etc.). Once the coals are at the proper heat, the user can maneuver them to one side of grill 26, i.e., first section 16 and insert fin 10 through grilling surface 28 to maintain the charcoal 33 in first section 16. Alternately, fin 10 can first be inserted within grilling surface 28 and then charcoal 33 deposited on charcoal grate 30. The user then places food 34 on grilling surface 28 in second section 17 and, optionally, covers grill 26 with lid 37. The user may control the entrance of air into the interior of grill 26 via air baffle 36. The user may then add extra charcoal 33 or smoke material (e.g., hickory, mesquite, cherry wood, etc.) to the charcoal 33 as desired. Food 34 will slowly cook with the desired heat and smoke from charcoal 33 as described herein, without flare-ups.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. A method for converting a charcoal grill into a heat smoker, the charcoal grill including at least one air vent, a grilling surface situated above a charcoal grate, and a charcoal grate lid configured to allow for the placement of charcoal upon the charcoal grate, the method comprising:
inserting a fin at least partially through the grilling surface such that the fin separates the charcoal grill into a first section and a second section, the fin positioned within the charcoal grill such that charcoal placed within the first section of the charcoal grill is prevented from entering the second section of the charcoal grill, the separation fin including at least one opening configured to allow smoke to pass therethrough; and
igniting the charcoal such that air entering the grill through the at least one air vent pulls heat and smoke emanating from the ignited charcoal around the fin and through the at least one opening in the fin to smoke food on the grilling surface.

2. The method of claim 1, further comprising:
covering the grilling surface with a lid, the lid including one of the at least one air vent; and
arranging the lid over the grilling surface such that air vent in the lid is situated away from the fin and above the second section of the grill.

3. The method of claim 1, wherein the fin is inserted within the grilling surface grill such that drippings from the cooked food residing on the grilling surface in the second section of the grill cannot drip on the charcoal situated in the first section.

4. The method of claim 1, further comprising adjusting the air vent on the lid in order to control air flow across the grilling surface during cooking.

5. The method of claim 1, wherein the at least one opening comprises at least one horizontally disposed slot, at least one vertically disposed slot, and at least one arcuate shaped opening.

6. The method of claim 1, wherein at least one of the two side edges is tapered in order to fit within a curved grill.

7. A fin for converting a charcoal grill into a heat smoker, the charcoal grill including at least one air vent, a grilling surface situated above a charcoal grate, and a charcoal grate lid configured to allow for the placement of charcoal upon the charcoal grate, the fin comprising:
a top edge, a bottom edge, and two side edges;
a front surface, and a back surface; and
at least one opening such that air entering the grill through the at least one air vent pulls heat and smoke emanating from ignited charcoal around the fin and through the at least one opening in the fin to smoke food on the grilling surface,
the fin configured to be inserted at least partially through the grilling surface, the insertion of the fin resulting in separation of the charcoal grill into a first section and a second section, such that the fin prevents the charcoal placed in the charcoal grate in the first section of the charcoal grill from entering the second section of the charcoal grill.

8. The fin of claim 7, wherein the at least one opening comprises:
at least one horizontally disposed slot;
at least one vertically disposed slot; and
at least one arcuate shaped opening.

9. The fin of claim 7, wherein at least one of the two side edges is tapered in order to fit within a curved grill.

10. A fin for converting a charcoal grill into a heat smoker, the charcoal grill including at least one air vent, a grilling surface situated above a charcoal grate, and a charcoal grate lid configured to allow for the placement of charcoal upon the charcoal grate, the fin comprising:
a top edge, a bottom edge, and two side edges, at least one of the two side edges being tapered in order to fit within a curved grill;
a front surface, and a back surface; and
at least one opening such that air entering the grill through the at least one air vent pulls heat and smoke emanating from ignited charcoal around the fin and through the at least one opening in the fin to smoke food on the grilling surface, the at least opening comprising:
a first column of horizontally disposed slots and a second column of horizontally disposed slots;
at least one vertically disposed slot situated between the first column and the second column;
a plurality of circular openings situated near the top edge of the fin; and
an oval-shaped opening situated between two of the plurality of circular openings,
the fin configured to be inserted at least partially through the grilling surface, the insertion of the fin resulting in separation of the charcoal grill into a first section and a second section, such that the fin prevents the charcoal placed in the charcoal grate in the first section of the charcoal grill from entering the second section of the charcoal grill.
